(19) United States
(12) Patent Application Publication
(10) Pub. No.: US 2016/0125485 A1
(43) Pub. Date: May 5, 2016

(54) SYSTEM, METHOD AND APPARATUS TO FORECAST ENERGY DEMAND FROM PAYMENT DATA SUMMARY

(71) Applicant: MasterCard International Incorporated, Purchase, NY (US)

(72) Inventor: Justin Xavier Howe, San Francisco, CA (US)

(21) Appl. No.: 14/532,486

(22) Filed: Nov. 4, 2014

(51) Int. Cl. G06Q 30/02; G06Q 50/06

(52) U.S. Cl. CPC G06Q 30/0283; G06Q 50/06

(57) ABSTRACT

A system, method, and computer-readable storage medium to forecast energy demand from payment data.

### BACKGROUND

1. Field of the Disclosure

Aspects of the disclosure relate in general to forecasting energy demand for utilities. Aspects include an apparatus, system, method and computer-readable storage medium to forecast energy demand from payment data.

2. Description of the Related Art

By their very nature, electrical utilities either generate or purchase electrical power from power plants. A power plant (also referred to as a generating station, power station, powerhouse or generating plant) is an industrial facility for generating electric power. At the center of nearly all power plants is a generator, a rotating machine that converts mechanical power into electrical power by creating relative motion between a magnetic field and a conductor. The energy source harnessed to turn the generator varies widely. It depends chiefly on which fuels are easily available and cost effective, and on the types of technology to which the utility has access. Most power plants in the world burn fossil fuels, such as coal, oil, and natural gas to generate electricity, and some use nuclear power, but there is an increasing use of cleaner renewable sources such as solar, wind, wave and hydroelectric.

The construction and operation of a power plant requires a large capital investment and expenditure. While electrical utilities try to have capacity that exceeds the demand of users, operating a power plant is expensive, and operating a power plant beyond the necessary is a waste of resources.

In a different art, a payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards provide the clients of a financial institution (“cardholders”) with the ability to pay for goods and services without the inconvenience of using cash. For example, traditionally, whenever travelers leave home, they carried large amounts of cash to cover journey expenditures, such as transportation, lodging, and food. Payment cards eliminate the need for carrying large amounts of currency. Moreover, in international travel situations, payment cards obviate the hassle of changing currency.

### SUMMARY

Embodiments include a system, device, method and computer-readable medium to forecast energy demand from payment data.

In a method embodiment, a method forecasts energy demand from payment data. A network interface receives a request for a utility forecast from a utility service. The request specifies a region and a time period for the utility forecast. A processor parses a plurality of payment card transaction data or travel transaction data from a Global Distribution System (GDS) to determine an absent household. A Global Distribution System is a network that enables automated transactions between third parties and booking agents in order to provide travel-related services to end consumers. A GDS can link services, rates and bookings consolidating products and services across airline reservations, hotel reservations, car rentals and activities. The payment card transaction or travel transaction data is associated with a cardholder that resides within the specified region. The payment card transaction or travel transaction data contains a travel itinerary. The travel itinerary includes a travel time period. The processor determines a number of the absent households during at least part of the time period based on the travel time period. For each of the absent households, past utility usage is retrieved from a non-transitory computer-readable medium. For each of the absent households, the processor calculates a reduction in utility demand based on the travel time period. The processor aggregates a total utility demand forecast based on the reduction in utility demand. The network interface reports the total utility demand forecast to the utility service.

A system embodiment includes a network interface, a processor, and a non-transitory computer-readable storage medium. The network interface receives a request for a utility forecast from a utility service. The request specifies a region and a time period for the utility forecast. A processor parses a plurality of payment card transaction data or travel transaction data from a GDS to determine an absent household. The payment card transaction or travel transaction data is associated with a cardholder that resides within the specified region. The payment card transaction or travel transaction data contains a travel itinerary. The travel itinerary includes a travel time period. The processor determines a number of the absent households during at least part of the time period based on the travel time period. For each of the absent households, past utility usage is retrieved from a non-transitory computer-readable medium. For each of the absent households, the processor calculates a reduction in utility demand based on the travel time period. The processor aggregates a total utility demand forecast based on the reduction in utility demand. The network interface reports the total utility demand forecast to the utility service.

In a non-transitory computer-readable medium embodiment, the non-transitory computer-readable medium is encoded with data and instructions. When executed by a computing device, the instructions cause the computing device to execute a method forecasting energy demand from payment data. A network interface receives a request for a utility forecast from a utility service. The request specifies a region and a time period for the utility forecast. A processor parses a plurality of payment card transaction data or travel transaction data from a GDS to determine an absent household. The payment card transaction or travel transaction data is associated with a cardholder that resides within the specified region. The payment card transaction or travel transaction data contains a travel itinerary. The travel itinerary includes a travel time period. The processor determines a number of the absent households during at least part of the time period based on the travel time period. For each of the absent households, past utility usage is retrieved from a non-transitory computer-readable medium. For each of the absent households, the processor calculates a reduction in utility demand based on the travel time period. The processor aggregates a total utility demand forecast based on the reduction in utility demand. The network interface reports the total utility demand forecast to the utility service.

### BRIEF DESCRIPTION OF THE DRAWINGS

FIG. 1 is a block diagram illustrating a system to forecast energy demand from payment data.

FIG. 2 is an expanded block diagram of an exemplary embodiment of a server architecture of a payment card network embodiment configured to forecast energy demand from payment data.

FIG. 3 illustrates a method to forecast energy demand from payment data.

### DETAILED DESCRIPTION

One aspect of the disclosure includes the realization that cardholder transactions can be used to predict travel by cardholders.

Another aspect of the disclosure includes the understanding that when a cardholder is traveling, their household electrical use is reduced significantly.

A further aspect of the disclosure is that by predicting anticipated travel by cardholders in a region a system can predict the reduction of demand on an electrical utility.

A payment card is a card that can be used by a cardholder and accepted by a merchant to make a payment for a purchase or in payment of some other obligation. It is understood by those familiar with the art that the term “payment card” includes credit cards, debit cards, charge cards, and Automated Teller Machine (ATM) cards. In addition to payment cards, it is understood by those familiar with the art that the embodiments described herein apply equally to payments via mobile devices (such as key fobs, mobile phones, tablet computers, and the like), electronic wallets, virtual payment cards, cloud-based payment devices, cashless payment devices/methods, or computers.

Embodiments of the present disclosure anticipate travel by cardholders through analyzing personally identifiable information in travel-related payment card addenda, GDS, or Billing Service Provider (BSP) information (a unique location code identifying a specific travel agency), or geo-location inferred from authorization data. The embodiments further use the anticipated travel to predict a resulting reduction in energy demand.

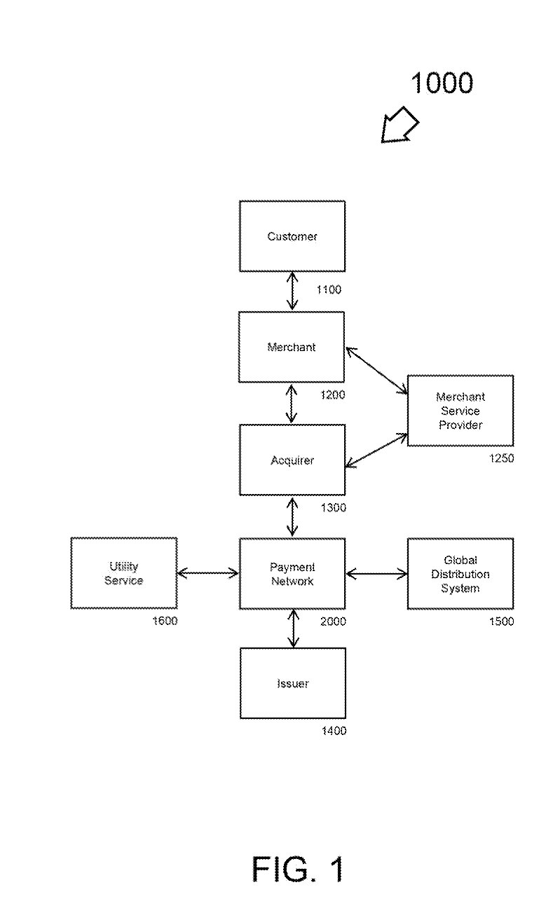

The systems and processes are not limited to the specific embodiments described herein. FIG. 1 is a block diagram 1000 illustrating a financial transaction using a payment card payment system configured to forecast energy demand from payment data.

A utility service 1600 contacts a payment network 2000 to request a forecast energy demand within a specific region at a specific time period. A utility service 1600 may be any utility known in the art. For the sake of example, an electrical utility service will be used, but it is understood that other utility services, such as a water or natural gas utility could use the systems and processes described herein.

It is understood that the anticipated travel detection may occur at either at an issuer 1400 or at a payment network 2000. For sake of example only, the present disclosure will describe a payment network-based system, such as the payment system using the MasterCard® interchange, Cirrus® network, or Maestro®. The MasterCard interchange is a proprietary communications standard promulgated by MasterCard International Incorporated for the exchange of financial transaction data between financial institutions that are customers of MasterCard International Incorporated. Cirrus is a worldwide interbank network operated by MasterCard International Incorporated linking debit and payment cards to a network of ATMs throughout the world. Maestro is a multi-national debit card service owned by MasterCard International Incorporated.

In a financial payment system, a financial institution called the “issuer” 1400 issues a payment card to a consumer 1100, who uses a payment card to tender payment at a merchant 1200 or withdraw cash from an Automated Teller Machine. For the purposes of this disclosure, the term customer and cardholder are synonymous when the customer uses a payment card for payment.

In one example, a cardholder presents the payment card at a merchant 1200. Typically, a merchant 1200 may be a vendor, service provider, or any other provider of goods or services; in this particular example, the merchant 1200 is a provider of a travel-related service, such as an airline, rental car company, rail service, or any other travel-related service known in the art.

The merchant 1200 is affiliated with a financial institution. This financial institution is usually called the “acquiring bank,” “merchant bank” or “acquirer” 1300. When a payment card is tendered at a merchant 1200, the merchant 1200 electronically requests authorization from the acquirer 1300 for the amount of the purchase. In the case of a physical payment card, the request is performed electronically with the consumer's account information from the face of the payment card, the magnetic stripe on the payment card or for CHIP enabled payment cards, via the computer chip imbedded within the card. The account information and transaction information are forwarded to transaction processing computers of the acquirer 1300.

Furthermore in some embodiments, a merchant service provider 1250 may connect to an acquirer 1300 on behalf of merchant 1200. An acquirer 1300 may authorize a third party to perform transaction processing on its behalf. In this case, the merchant 1200 will be configured to communicate with the third party. Such a third party is usually called a “merchant service provider” 1250 or an “acquiring processor.”

Using a payment network 2000, the computers of the acquirer 1300 or the merchant's acquiring processor 1250 will communicate via an authorization message or PIN network with the computers of the issuer 1400 to determine whether the consumer's account is in good standing and whether the transaction is likely to be fraudulent.

In the case of a traditional credit card, when a request for authorization is accepted, the available credit balance of cardholder's account is decreased, and a payment is later made to merchant 1200 via acquirer 1300.

After a transaction is captured, the transaction is communicated between the merchant 1200, the acquirer 1300, and the issuer 1400. In some embodiments, there may be a clearing process and a settlement process. A clearing process is a reconciliation process, helping issuers/acquirers learn about the amount to be transferred. A settlement process is a funds transfer process. Typically the clearing process and settlement process are generally performed as batch processes. During the clearing process, the merchant 1200 or acquirer 1300 provides encoded details of the transaction to the payment network 2000. The transaction detail includes interchange rate/category for the transaction, the time/date of the transaction, the type of transaction, where the transaction occurred, the amount of the transaction and the Primary Account Number (PAN) of the payment card involved in the transaction. Additionally, merchants may attach addendum details to the transaction information. Such addendum information may include, but is not limited to:

Passenger Transport Detail—General Ticket Information;

Passenger Transport Detail—Trip Leg Data;

Passenger Transport Detail—Rail Data;

Vehicle Rental Detail;

Lodging Detail;

Temporary Services;

Shipping/Courier Services;

Electronic Invoice—Transaction Data;

Electronic Invoice—Party Information;

Payment Transaction Addendum Telephony Billing—Summary;

Telephony Billing—Detail;

Travel Agency Detail;

Lodged Account Detail;

Private Label Common Data;

Private Label Line Item;

Healthcare—IIAS Detail;

Corporate Card Common Data Requirements;

Corporate Card Fleet Transaction Information;

Corporate Line Item Detail Generic Detail; or

Any other addenda information known in the art.

While the process is discussed in greater detail below, the concepts are best explained by example. The payment network 2000 may anticipate the cumulative travel by any number of cardholders in a region at a specific time period. Suppose a cardholder purchases a travel-related service from a merchant 1200, such as plane, train, bus, or other travel tickets, hotels, rental-cars and the like. The merchant embeds personally identifiable information within the addenda, GDS, or BSP information, such as a name or frequent flier number.

The addenda information can alternatively be supplemented from a Global Distribution System (GDS) 1500 or other travel data provider. As understood in the art, a GDS 1500 is generally a network that enables transactions between travel service providers (e.g., airlines, train operators, rental car companies) and travel reservation agents in order to provision travel-related services to end users.

Additionally, geo-location inferred from authorization data may also be used to factor in determining current travel. For example, if a cardholder has just made a purchase at a store in Prague, Czech Republic, it is safe to assume they will probably not be home for dinner in San Francisco, Calif.

The cardholders with anticipated travel will be assumed to be absent from their residence when traveling. Consequently, there will be a reduction in energy use at a residence when the cardholder is absent. By determining the percentage of people traveling away from a region during a specific time period, an amount of energy demand in the region can be anticipated.

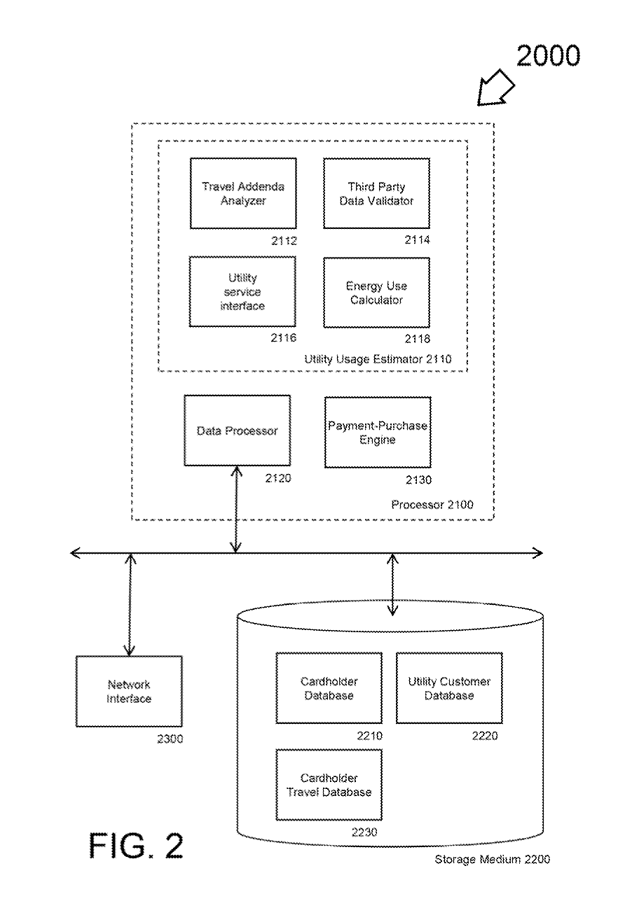

Embodiments will now be disclosed with reference to a block diagram of an exemplary payment network server of FIG. 2, configured to forecast energy demand from payment data, constructed and operative in accordance with an embodiment of the present disclosure. It is understood that in some embodiments, the server of FIG. 2 may reside at an issuer instead of a payment network; however, for the sake of example only, an embodiment that resides at payment network will be described.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a utility usage estimator 2110, payment-purchase engine 2130, and a data processor 2120.

Data processor 2120 interfaces with storage media 2200 and network interface 2300. The data processor 2120 enables processor 2100 to locate data on, read data from, and writes data to, these components.

Payment-purchase engine 2130 performs payment and purchase transactions, and may do so in conjunction with utility usage estimator 2110.

Utility usage estimator 2110 is the structure that analyzes the transaction information received from an acquirer, detects and anticipates travel by cardholders, and estimates the resulting change in energy demand caused by anticipated travelers. Utility usage estimator 2110 may further comprise: a travel addenda analyzer 2112, a third party data validator 2114, a utility service interface 2116, and an energy use calculator 2118.

Travel addenda analyzer 2112 is configured to extract payment addenda information from transaction data, and determine when the cardholder will be absent from their residence based on anticipated travel determined from the payment addenda information. Travel addenda analyzer 2112 may validate or supplement the payment addenda information by using a third party data validator 2114. Travel addenda analyzer 2112 embodiments may adjust for a certain minimum energy use by a residence, and factor the number of people traveling within a household. For example, in a household of four individuals, there is a tangible difference in energy use when only one person is traveling, rather than all four individuals are traveling

Third party data validator 2114 is a structure configured to validate addenda information against cardholder travel database 2230. Such cardholder travel database 2230 may be supplemented from a GDS 1500. In other embodiments, no travel addenda information is received, and only GDS or BSP data is received.

Utility service interface 2116 is an application program interface (API) or other structure configured to communicate with utility service 1600 via a network interface 2300.

Energy use calculator 2118 is a structure configured to estimate energy demand in a specified region and time period based on the input of travel addenda analyzer 2112.

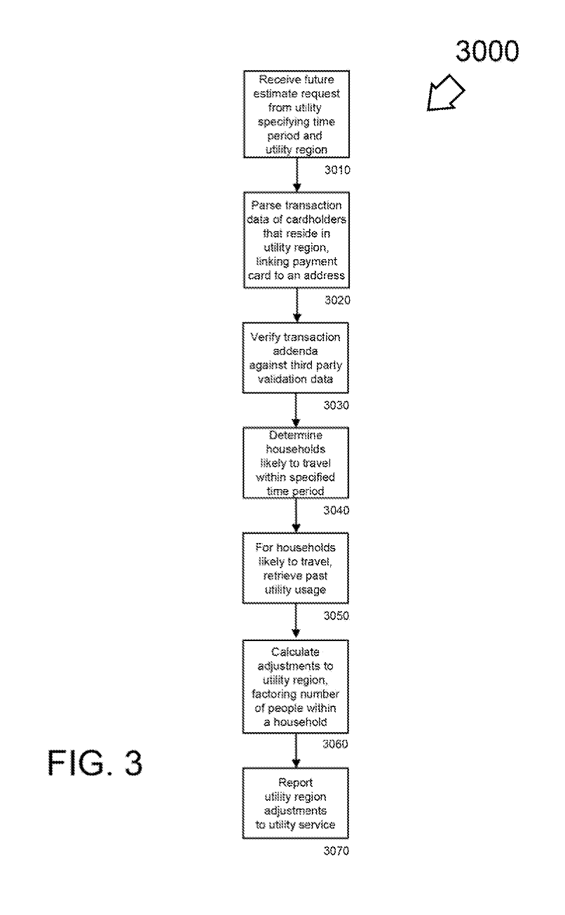

The functionality of all the utility usage estimator 2110 structures is elaborated in greater detail in FIG. 3.

These structures may be implemented as hardware, firmware, or software encoded on a computer readable medium, such as storage medium 2200. Further details of these components are described with their relation to method embodiments below.

Non-transitory computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a cardholder database 2210, a utility customer database 2220, and cardholder travel database 2230. Cardholder database 2210 stores cardholder information; such cardholder information may include personally identifiable information for cardholders and cardholder transaction data received during the clearing process. Utility customer database 2220 stores the customer information for the utility, and may include historical usage information for each utility customer. Cardholder travel database 2230 is configured to store anticipated travel by cardholders, as determined by travel addenda analyzer 2112. In some embodiments, cardholders may self-report anticipated travel; cardholder travel database 2230 stores this information.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment server to communicate with acquirer 1300, issuer 1400, global distribution system 1500, and utility service 1600.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

FIG. 3 illustrates a process 3000 to forecast energy demand from payment data, constructed and operative in accordance with an embodiment of the present disclosure. It is understood by those familiar with the art that process 3000 is a non-real time clearing process, but in alternate embodiments may be a real time process. Conventionally, a clearing process is a non-real time process. Furthermore, it is understood that process 3000 or variations thereof may occur at an issuer 1400 or at a payment network 2000. For the sake of example only, this disclosure will discuss a payment network 2000 embodiment.

At block 3010, payment network 2000 receives a future usage estimate request from utility service 1600. The request specifies the time period and utility region. The time period may be specified by a date range, hour, day, week, month, quarter or year, for example. A utility region is any geographic region or subset serviced by utility service 1600. The request is received at the network interface 2300, communicating with the utility service interface 2116.

Travel addenda analyzer 2112 retrieves a list of known cardholders that reside within the geographic region, as stored in the utility customer database. From the list of known cardholders, travel addenda analyzer 2112 parses the cardholders' transaction data, as stored in cardholder database 2210, block 3020. In some embodiments, the utility service 1600 may provide a mapping of PANs, with which cardholders paid their bill to known geo-locations or utility regions. In other embodiments, the utility service 1600 may provide the addresses of accounts to the payment network 2000, which can then identify PANs using methods known in the art. The transaction data may be part of data from many transactions received via a batch process. The transaction data may contain a cardholder identifier associated with a cardholder, and addenda for the transaction. A cardholder identifier may be a PAN of a payment card used in the transaction. The addenda may contain personally identifiable information for the cardholder or another individual. The travel addenda analyzer 2112 of the utility usage estimator 2110 extracts the associated addenda information from transaction data. These processes are intended to be conducted in accordance with applicable data privacy and usage laws and regulations. For example, in some embodiments, cardholders may first elect to “opt in” to this process.

In some instances, the addenda are incomplete. In such instances, third party data validator 2114 verifies the parsed addenda information against third party validation data, which may be provided by global distribution system 1500, block 3030. Such third party validation data may include flight details, such as: origin, destination, carrier, flight number, departure times, travel date, fare class and stopover code information. As part of the verification process, the addenda are corrected and details are added from third party data, if necessary. Note that in cases where GDS data is used to validate addenda data, the GDS records and addenda data may be matched by PAN, transaction date and transaction amount.

In other embodiments, GDS, or BSP information may be used in addition to, or instead of, the addenda information.

With the parsed addenda information, travel addenda analyzer 2112 may predict the cardholder households likely to travel within the specified time period, block 3040, such as the hour or day of the travel.

For each of the cardholder households likely to travel, their past utility usage is retrieved from utility customer database 2220, block 3050. In some instances, when past utility usage for a particular cardholder household is not available, an average past utility usage or benchmark energy consumption may be retrieved.

At block 3060, energy use calculator 2118 determines adjustments to demand for the utility region.

For each cardholder determined to be absent (away from home) during the time period, energy use calculator 2118 adjusts the expected utility use, such as the hour or day of the travel. Embodiments may adjust for a certain minimum energy use by a residence, and factor the number of people traveling within a household. By factoring the number of people traveling within a household, the energy use calculator 2118 may incrementally adjust energy use predictions. For example, in a household of four individuals, there is a tangible difference in energy use when only one person is traveling, rather than all four individuals are traveling.

The aggregate total energy reduction for the entire specified region may then be predicted based off of the percentage of cardholders absent, and the adjustment to the absent residences, resulting in a total utility demand forecast.

Utility service interface 2116 reports the total utility demand forecast to utility service 1600 with the network interface 2300, block 3070. The utility service 1600 can then adjust their energy production accordingly.

Process 3000 then ends.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, with a network interface, a request for a utility forecast from a utility service, the request specifying a region and a time period for the utility forecast;
parsing, with a processor, a plurality of payment card transaction data or travel transaction data from a Global Distribution System (GDS) to determine an absent household, the payment card transaction or travel transaction data being associated with a cardholder that resides within the specified region, the payment card transaction or travel transaction data containing a travel itinerary, the travel itinerary including a travel time period;
determining, with the processor, a number of the absent households during at least part of the time period based on the travel time period;
for each of the absent households, retrieving past utility usage from a non-transitory computer-readable medium;
for each of the absent households, calculating with the processor a reduction in utility demand based on the travel time period;
aggregating, with the processor, a total utility demand forecast based on the reduction in utility demand;
reporting, with the network interface, the total utility demand forecast to the utility service.

2. The processing method of claim 1, wherein the payment card transaction data includes geo-location data inferred from authorization data.

3. The processing method of claim 1, further comprising:
determining, with the processor, a number of individuals absent from an absent household during at least part of the time period based on the travel time period.

4. The processing method of claim 3, wherein the calculating with the processor a reduction in utility demand based on the travel time period further factors the number of individuals absent from the absent household.

5. The processing method of claim 4, wherein travel time period is specified by a date range, hour, day, week, month, quarter or year.

6. The processing method of claim 5, wherein the utility service is an electrical utility service.

7. The processing method of claim 5, wherein the utility service is a water utility service.

8. A system comprising:
a network interface configured to receive a request for a utility forecast from a utility service, the request specifying a region and a time period for the utility forecast;
a processor configured to parse a plurality of payment card transaction data or travel transaction data from a Global Distribution System (GDS) to determine an absent household, the payment card transaction or travel transaction data being associated with a cardholder that resides within the specified region, the payment card transaction or travel transaction data containing a travel itinerary, the travel itinerary including a travel time period, to determine a number of the absent households during at least part of the time period based on the travel time period, for each of the absent households to retrieve past utility usage from a non-transitory computer-readable medium, for each of the absent households to calculate a reduction in utility demand based on the travel time period, to aggregate a total utility demand forecast based on the reduction in utility demand;
the network interface is further configured to report the total utility demand forecast to the utility service.

9. The system of claim 8, wherein the payment card transaction data includes geo-location data inferred from authorization data.

10. The system of claim 8, further comprising:
determining, with the processor, a number of individuals absent from an absent household during at least part of the time period based on the travel time period.

11. The system of claim 10, wherein the calculating with the processor a reduction in utility demand based on the travel time period further factors the number of individuals absent from the absent household.

12. The system of claim 11, wherein travel time period is specified by a date range, hour, day, week, month, quarter or year.

13. The system of claim 12, wherein the utility service is an electrical utility service.

14. The system of claim 12, wherein the utility service is a water utility service.

15. A non-transitory computer readable medium encoded with data and instructions, when executed by a computing device the instructions causing the computing device to:
receive, with a network interface, a request for a utility forecast from a utility service, the request specifying a region and a time period for the utility forecast;
parse, with a processor, a plurality of payment card transaction data or travel transaction data from a Global Distribution System (GDS) to determine an absent household, the payment card transaction or travel transaction data being associated with a cardholder that resides within the specified region, the payment card transaction or travel transaction data containing a travel itinerary, the travel itinerary including a travel time period;
determine, with the processor, a number of the absent households during at least part of the time period based on the travel time period;
for each of the absent households, retrieve past utility usage from the non-transitory computer-readable medium;
for each of the absent households, calculate with the processor a reduction in utility demand based on the travel time period;
aggregate, with the processor, a total utility demand forecast based on the reduction in utility demand;
report, with the network interface, the total utility demand forecast to the utility service.

16. The non-transitory computer readable medium of claim 15, wherein the payment card transaction data includes geo-location data inferred from authorization data.

17. The non-transitory computer readable medium of claim 15, wherein the instructions further causes the computing device to:
determine, with the processor, a number of individuals absent from an absent household during at least part of the time period based on the travel time period.

18. The non-transitory computer readable medium of claim 17, wherein the calculating with the processor a reduction in utility demand based on the travel time period further factors the number of individuals absent from the absent household.

19. The non-transitory computer readable medium of claim 18, wherein travel time period is specified by a date range, hour, day, week, month, quarter or year.

20. The non-transitory computer readable medium of claim 19, wherein the utility service is an electrical utility service.
